(19) United States
(12) Patent Application Publication
(10) Pub. No.: US 2007/0070013 A1
(43) Pub. Date: Mar. 29, 2007

(54) COMMON VOLTAGE MODIFICATION CIRCUIT AND THE METHOD THEREOF

(76) Inventors: Yu-Cheng Chen, Kaohsiung Hsien (TW); I-Cheng Shih, Taoyuan County (TW); Tai-Ming Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,864

(22) Filed: Sep. 27, 2005

(51) Int. Cl. G09G 3/36

(52) U.S. Cl. 345/94

(57) ABSTRACT

A common voltage modification circuit and a method thereof are provided. The present invention is characterized in that an output voltage is provided to a storage capacitor in each of the pixels in a thin-film transistor liquid crystal display (TFT LCD) based on a predetermined voltage and a common voltage. Wherein a liquid crystal capacitor of each pixel is electrically connected to the common voltage. In addition, the phase and amplitude of the output voltage are same as the phase and amplitude of the common voltage. Finally, the result of subtracting the output voltage from the common voltage is equal to the absolute value of the predetermined voltage.

### BACKGROUND OF THE INVENTION

1.Field of the Invention

The present invention relates to a common voltage modification circuit and a method thereof suitable for a thin-film transistor liquid crystal display (TFT LCD), and more particularly, to a common voltage modification circuit and a method thereof for alternating current (AC) modulation.

2.Description of the Related Art

Typically, a pixel on the general TFT LCD comprises a thin film transistor (TFT), a storage capacitor, and a liquid crystal capacitor. If the storage capacitor has a metal-insulator semiconductor (MIS) structure, the quantity of the photo masks in the fabricating process is reduced, so as to reduce the manufacturing cost.

In the MIS structure forming a storage capacitor disclosed in U.S. Pat. No. 6,392,623, a plurality of driving voltages with different levels are applied on the common electrode electrically connected to one terminal of the storage capacitor and applied on the counter electrode electrically connected to one terminal of the liquid crystal capacitor, respectively. Accordingly, the incorrectness of the gray scale voltage occurred in the active matrix thin-film transistor liquid crystal display (AMTFT LCD) due to the congenital factor of the fabricating process is eliminated. However, here the common voltage is a constant negative voltage.

The voltage amplitude output from the source driver integrated circuit is reduced by applying the AC common voltage, such that the power consumption is reduced. If the invention disclosed in U.S. Pat. No. 6,392,623 mentioned above is applied on the TFT LCD panel of the AC common voltage, the gray scale voltage error is occurred when the TFT is turned off, which inevitably deteriorates the quality.

### SUMMARY OF THE INVENTION

Therefore, it is an object of the present invention to provide a common voltage modification circuit. Wherein, the voltage amplitude output from the source driver integrated circuit is reduced by applying the AC common voltage, such that the power consumption is reduced, the correctness of the gray scale voltage is maintained, and the picture quality is further improved.

It is another object of the present invention to provide a method for modifying a common voltage. Wherein, the storage capacitor of MIS structure is applied in order to reduce the quantity of photo masks in fabricating process and to reduce the manufacturing cost and maintain the correctness of the quantity of charges in the storage capacitor, such that the picture quality is ensured.

In order to achieve objects mentioned above and others, the present invention provides a common voltage modification circuit. The common voltage modification circuit comprises a common voltage generator and an operation circuit. The common voltage generator provides a common voltage. The operation circuit receives a predetermined voltage and the common voltage, and provides an output voltage to a common electrode of a storage capacitor of each pixel in a thin-film transistor liquid crystal display (TFT LCD) based on the predetermined voltage and the common voltage. Both of the output voltage and the common voltage are alternating current (AC) voltages. A counter electrode of a liquid crystal capacitor in each of the pixels is electrically connected to the common voltage. The phase and amplitude of the output voltage are the same as the phase and amplitude of the common voltage, and the result of subtracting the output voltage from the common voltage is equal to an absolute value of the predetermined voltage.

In the common voltage modification circuit of an embodiment mentioned above, the predetermined voltage is a negative voltage, and the output voltage is equal to the common voltage plus the predetermined voltage.

In the common voltage modification circuit of an embodiment mentioned above, the predetermined voltage is a positive voltage, and the output voltage is equal to the common voltage minus the predetermined voltage.

In the common voltage modification circuit of an embodiment mentioned above, the storage capacitor of each pixel is the MIS structure.

In accordance with another aspect of the present invention, the present invention further provides a method for modifying a common voltage. In the modifying method, an output voltage is provided to the common electrode of the storage capacitor of each pixel in the TFT LCD based on a predetermined voltage and a common voltage. Wherein, both of the output voltage and the common voltage are the AC voltages, and the counter electrode of the liquid crystal capacitor of each pixel is electrically connected to the common voltage. In addition, the phase and amplitude of the output voltage are same as the phase and amplitude of the common voltage. Finally, the result of subtracting the output voltage from the common voltage is equal to the absolute value of the predetermined voltage.

As described in the preferred embodiment of the present invention, the present invention uses the common voltage, which is modified based on the predetermined voltage, as the output voltage, and outputs the output voltage to the storage capacitor of each pixel. Meanwhile, the common voltage is provided to the liquid crystal capacitor of each pixel. Since the predetermined voltage is constant, both of the output voltage and the common voltage are the AC voltages with the same phase and amplitude. Therefore, the MIS structure is used to reduce the quantity of photo masks in fabricating process, so as to reduce the manufacturing cost. In addition, the AC common voltage is used to reduce the voltage amplitude output from the source driver integrated circuit, so as to reduce the power consumption. Furthermore, the correctness of the gray scale voltage is maintained, and the correctness of the quantity of charges in the storage capacitor is maintained, such that the picture quality is ensured.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a partial circuit diagram of a TFT LCD according to the first embodiment of the present invention.

FIG. 2 schematically shows a timing diagram of the driving signals of a TFT LCD according to the first embodiment of the present invention.

FIG. 3 schematically shows a partial circuit diagram of a TFT LCD according to the second embodiment of the present invention.

### DESCRIPTION PREFERRED EMBODIMENTS

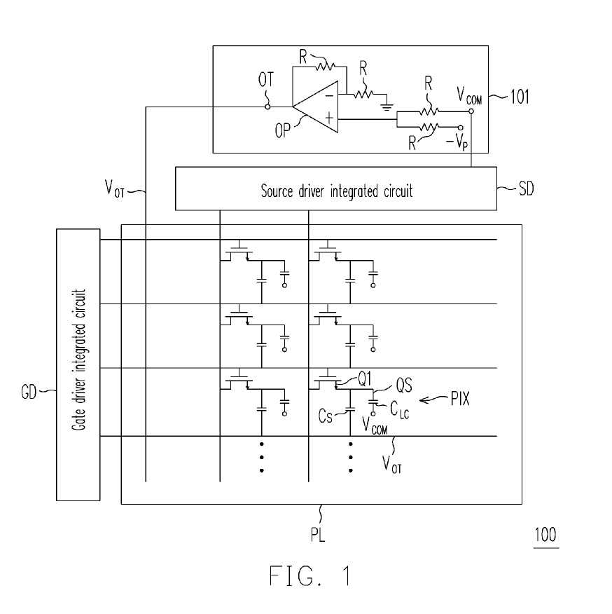

FIG. 1 schematically shows a partial circuit diagram of a TFT LCD 100 according to a first embodiment of the present invention. Referring to FIG. 1, the circuit of FIG. 1 comprises a source driver integrated circuit SD, a gate driver integrated circuit GD, a TFT LCD panel PL, and an operation circuit 101. The common voltage modification circuit in this embodiment comprises the operation circuit 101 and the source driver integrated circuit SD. Although the TFT LCD panel PL in FIG. 1 only has 6 pixels, actually any number of pixels can be displayed on the TFT LCD panel PL. For example, the magnified pixel PIX in FIG. 1 comprises a TFT Q1, a storage capacitor Cₛ, and a liquid crystal capacitor C_{LC}. Wherein, a gate of the TFT Q1 is electrically connected to the gate driver integrated circuit GD, and a drain of the TFT Q1 is electrically connected to the source driver integrated circuit SD. One terminal of the storage capacitor Cₛ is electrically connected to the TFT Q1, that is a pixel electrode QS. The other terminal of the storage capacitor Cₛ is electrically connected to an output terminal OT of the operation circuit 101. Finally, one terminal of the liquid crystal capacitor C_{LC} is electrically connected to the pixel electrode QS, and the other terminal of the liquid crystal capacitor C_{LC} is electrically connected to a common electrode on the other side of the substrate for electrically coupling to a common voltage Vcom. In the present embodiment, all of the storage capacitors Cₛ of pixels have the same MIS structure.

The pixel PIX is exemplified herein, when the TFT Q1 is turned off, in order to maintain the correct display of gray scale, the quantity of the charges on the storage capacitor Cₛ and the liquid crystal capacitor C_{LC} must be constant. Under the condition of both capacitances are not changed, the voltage across the storage capacitor Cₛ and the liquid crystal capacitor C_{LC} must be maintained as no change. In the present embodiment, the common voltage Vcom is an AC voltage. In order to maintain the voltage across the storage capacitor Cₛ as constant, the phase and amplitude of the voltage V_{OT} output from the operation circuit 101 must be the same as the phase and amplitude of the common voltage Vcom.

In order to achieve the objects mentioned above, the operation circuit 101 in the present embodiment receives a predetermined voltage −Vp and a common voltage Vcom, and provides an output voltage VOT to the storage capacitor Cₛ of each pixel in the TFT LCD 100 based on the predetermined voltage −Vp and the common voltage Vcom. Wherein, both of the predetermined voltage −Vp and the common voltage Vcom are the AC voltages, and the liquid crystal capacitor C_{LC} of each pixel is electrically connected to the common voltage Vcom. In addition, the phase and amplitude of the output voltage V_{OT} are same as the phase and amplitude of the common voltage Vcom. Finally, the result of subtracting the output voltage V_{OT} from the common voltage Vcom is equal to the absolute value of the predetermined voltage −Vp.

In the present embodiment, the common voltage Vcom is provided by the source driver integrated circuit SD, and the predetermined voltage −Vp is a negative voltage. Thus, the output voltage V_{OT} is equal to the common voltage Vcom plus the predetermined voltage −Vp. The value of the predetermined voltage −Vp is obtained according to U.S. Pat. No. 6,392,623 mentioned above. In other words, the predetermined voltage −Vp is equal to −Vpmax −Vdmax. Wherein, −Vpmax is the most negative voltage provided by the source driver integrated circuit SD to each pixel, and Vdmax is the voltage required for maintaining the depletion layer in the storage capacitor Cₛ of each pixel at a maximum width.

In order to summate the common voltage Vcom and the predetermined voltage −Vp, the operation circuit 101 of the present embodiment is implemented as a non-inverting adding circuit composed of an operational amplifier OP. As shown in FIG. 1, the operation circuit 101 comprises an operational amplifier OP and 4 resistors R. Wherein, an output terminal of the operational amplifier OP is electrically connected to an output terminal OT of the operation circuit 101. A first resistor R is electrically connected between the output terminal and an inverting input terminal of the operational amplifier OP. A first terminal of a second resistor R is electrically connected to the inverting input terminal of the operational amplifier OP, and a second terminal of the second resistor R is grounded. A third resistor R is electrically connected between a non-inverting input terminal of the operational amplifier OP and the common voltage Vcom. Finally, a fourth resistor R is electrically connected between the non-inverting input terminal of the operational amplifier OP and the predetermined voltage −Vp. Since the non-inverting adding circuit constituted by the operational amplifier is widely applied in the related art, its detail description is omitted herein.

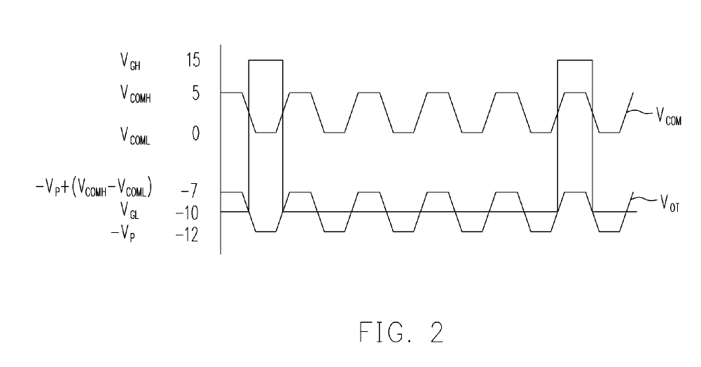

FIG. 2 schematically shows the input and output waveforms of the operation circuit 101. Wherein, V_{GH} and V_{GL} are the high and low voltage levels output from the gate driver integrated circuit GD respectively, and Vcom_{H} and Vcom_{L} are the maximum and minimum values of the common voltage Vcom respectively. In the present embodiment, the common voltage Vcom is swinging between 5V and 0V, and the output voltage V_{OT} is equal to the common voltage Vcom plus the predetermined voltage −Vp (i.e. −12V in the present embodiment). Therefore, the common voltage Vcom is swinging between −7V and −12V. It is obvious from FIG. 2 that the phase and amplitude of the output voltage V_{OT} is same as the phase and amplitude of the common voltage Vcom.

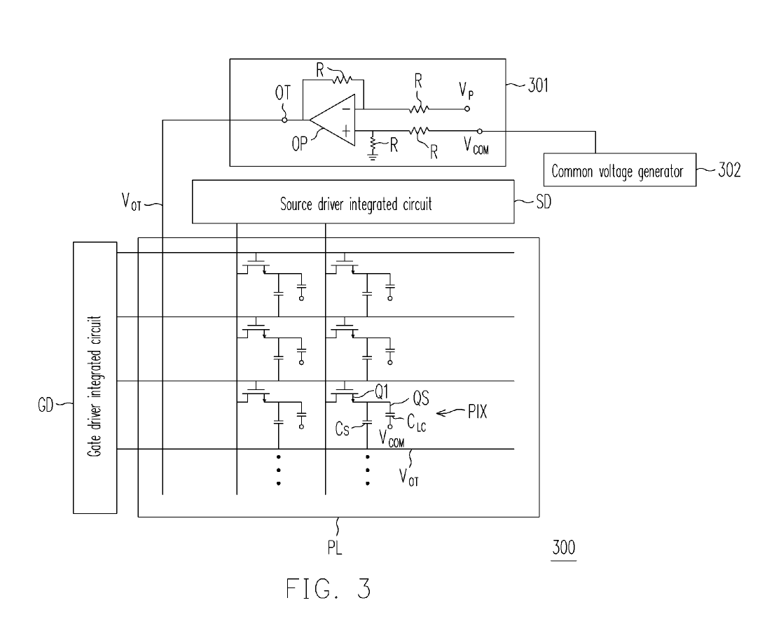

A second embodiment of the present invention is described hereinafter with referring to FIG. 3. FIG. 3 schematically shows a partial circuit diagram of a TFT LCD 300 according to the second embodiment of the present invention. The TFT LCD 300 comprises a source driver integrated circuit SD, a gate driver integrated circuit GD, a TFT LCD panel PL, an operation circuit 301, and a common voltage generator 302. The common voltage modification circuit in this embodiment comprises the operation circuit 301 and the common voltage generator 302.

As shown in FIG. 3, in the present embodiment, the common voltage Vcom is provided by the common voltage generator 302 rather than by the source driver integrated circuit SD. In addition, the predetermined voltage Vp in the present embodiment is a positive voltage, thus the output voltage V_{OT} is equal to the common voltage Vcom minus the predetermined voltage Vp. The predetermined voltage Vp in the present embodiment has the same value and opposite sign as the predetermined voltage in the embodiment mentioned above. In other words, the predetermined voltage Vp in the present embodiment is equal to −(−Vpmax)+Vdmax. Wherein, −Vpmax is the most negative voltage provided by the source driver integrated circuit SD to each pixel, and Vdmax is the voltage required for maintaining the depletion layer in the storage capacitor of each pixel at a maximum width.

In order to subtract the predetermined voltage Vp from the common voltage Vcom, the operation circuit 301 of the present embodiment is implemented as a subtraction circuit composed of an operational amplifier OP. As shown in FIG. 3, the operation circuit 301 comprises an operational amplifier OP and 4 resistors R. Wherein, an output terminal of the operational amplifier OP is electrically connected to an output terminal OT of the operation circuit 301. A first resistor R is electrically connected between the output terminal and an inverting input terminal of the operational amplifier OP. A second resistor R is electrically connected between the inverting input terminal of the operational amplifier OP and the predetermined voltage Vp. A third resistor R is electrically connected between a non-inverting input terminal of the operational amplifier OP and the common voltage Vcom. Finally, a first terminal of a fourth resistor R is electrically connected to the non-inverting input terminal of the operational amplifier OP, and a second terminal of the fourth resistor R is grounded. Since the subtraction circuit is widely applied in the industry and also well known by one of the ordinary skill in the art, its detail description is omitted herein.

The present invention is not necessarily limited to the operation circuits described in two embodiments mentioned above. It will be apparent to one of the ordinary skill in the art that other circuit may achieve the same effect. For example, an inverting adding circuit using the operational amplifier or other type of circuits such as a diode clamping circuit may be applied in the present invention as long as the same relationship exists between the output voltage and the common voltage of the operation circuit.

Finally, in addition to the common voltage modification circuit mentioned above, the present invention further provides a method for modifying a common voltage. The steps of the modifying method are fully described in the embodiment of the common voltage modification circuit mentioned above, thus its detail description is omitted herein.

As described in the embodiments mentioned above, in the present invention, an output voltage that had been modified based on the predetermined voltage is provided to the storage capacitor of each pixel. Meanwhile, the common voltage is provided to the liquid crystal capacitor of each pixel. Since the predetermined voltage is constant, both of the output voltage and the common voltage are the AC voltages with the same phase and amplitude. Therefore, the MIS structure is used to reduce the quantity of photo masks in fabricating process, so as to reduce the manufacturing cost. In addition, the AC common voltage is used to reduce the voltage amplitude output from the source driver integrated circuit, so as to reduce the power consumption. Furthermore, the correctness of the gray scale voltage is maintained, and the correctness of the quantity of charges in the storage capacitor is maintained, such that the picture quality is ensured.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A common voltage modification circuit, comprising:
a common voltage generator for providing a common voltage; and
an operation circuit, receiving a predetermined voltage and the common voltage, and providing an output voltage to a common electrode of a storage capacitor of each pixel in a thin-film transistor liquid crystal display (TFT LCD) based on the predetermined voltage and the common voltage; wherein
both of the output voltage and the common voltage are alternating current (AC) voltages, a counter electrode of a liquid crystal capacitor in each of the pixels is electrically connected to the common voltage, the phase and amplitude of the output voltage are the same as the phase and amplitude of the common voltage, and the result of subtracting the output voltage from the common voltage is equal to an absolute value of the predetermined voltage.

2. The common voltage modification circuit of claim 1, wherein the common voltage generator is a source driver integrated circuit of the TFT LCD.

3. The common voltage modification circuit of claim 1, wherein the predetermined voltage is a negative voltage, and the output voltage is equal to the common voltage plus the predetermined voltage.

4. The common voltage modification circuit of claim 3, wherein the predetermined voltage is equal to −Vpmax−Vdmax, −Vpmax is a most negative voltage provided by the source driver integrated circuit to each of the pixels, and Vdmax is a voltage required for maintaining a depletion layer in the storage capacitor in each of the pixels at a maximum width.

5. The common voltage modification circuit of claim 3, further comprising:
an operational amplifier having an output terminal of the operational amplifier electrically connected to an output terminal of the common voltage modification circuit;
a first resistor electrically connected between the output terminal and an inverting input terminal of the operational amplifier;
a second resistor having a first terminal of the second resistor electrically connected to the inverting input terminal of the operational amplifier, and a second terminal grounded;
a third resistor electrically connected between a non-inverting input terminal of the operational amplifier and the common voltage; and
a fourth resistor electrically connected between the non-inverting input terminal of the operational amplifier and the predetermined voltage.

6. The common voltage modification circuit of claim 1, wherein the predetermined voltage is a positive voltage, and the output voltage is equal to the common voltage minus the predetermined voltage.

7. The common voltage modification circuit of claim 6, wherein the predetermined voltage is equal to −(−Vpmax)+Vdmax, −Vpmax is a most negative voltage provided by the source driver integrated circuit to each of the pixels, and Vdmax is a voltage required for maintaining a depletion layer in the storage capacitor in each of the pixels at a maximum width.

8. The common voltage modification circuit of claim 6, further comprising:
an operational amplifier having an output terminal of the operational amplifier electrically connected to an output terminal of the common voltage modification circuit;
a first resistor electrically connected between the output terminal and an inverting input terminal of the operational amplifier;
a second resistor electrically connected between the inverting input terminal of the operational amplifier and the predetermined voltage;
a third resistor electrically connected between a non-inverting input terminal of the operational amplifier and the common voltage; and
a fourth resistor having a first terminal electrically connected to the non-inverting input terminal of the operational amplifier, and a second terminal grounded.

9. The common voltage modification circuit of claim 1, wherein each of the pixels comprises:
a thin film transistor (TFT) having a gate electrically connected to a gate driver integrated circuit of the TFT LCD, and a drain electrically connected to a source driver integrated circuit of the TFT LCD;
a storage capacitor electrically connected between a source of the TFT and the output voltage; and
a liquid crystal capacitor electrically connected between the source of the TFT and the common voltage.

10. The common voltage modification circuit of claim 1, wherein the storage capacitor in each of the pixels is a metal-insulator semiconductor (MIS) structure.

11. A method for modifying a common voltage, characterized in:
providing an output voltage to a common electrode of a storage capacitor in each of the pixels of a TFT LCD based on a predetermined voltage and a common voltage, wherein both of the output voltage and the common voltage are AC voltages, a counter electrode of a liquid crystal capacitor in each of the pixels is electrically connected to the common voltage, the phase and amplitude of the output voltage are the same as the phase and amplitude of the common voltage, and the result of subtracting the output voltage from the common voltage is equal to an absolute value of the predetermined voltage.

12. The method for modifying the common voltage of claim 11, wherein the common voltage is provided by a source driver integrated circuit of the TFT LCD.

13. The method for modifying the common voltage of claim 11, wherein the common voltage is provided by a common voltage generator of the TFT LCD.

14. The method for modifying the common voltage of claim 11, wherein the predetermined voltage is a negative voltage, and the output voltage is equal to the common voltage plus the predetermined voltage.

15. The method for modifying the common voltage of claim 14, wherein the predetermined voltage is equal to −Vpmax−Vdmax, −Vpmax is a most negative voltage provided by the source driver integrated circuit to each of the pixels, and Vdmax is a voltage required for maintaining a depletion layer in the storage capacitor in each of the pixels at a maximum width.

16. The method for modifying the common voltage of claim 11, wherein the predetermined voltage is a positive voltage, and the output voltage is equal to the common voltage minus the predetermined voltage.

17. The method for modifying the common voltage of claim 16, wherein the predetermined voltage is equal to −(−Vpmax)+Vdmax, −Vpmax is a most negative voltage provided by the source driver integrated circuit to each of the pixels, and Vdmax is a voltage required for maintaining a depletion layer in the storage capacitor in each of the pixels at a maximum width.

18. The method for modifying the common voltage of claim 11, wherein the storage capacitor in each of the pixels is a metal-insulator semiconductor (MIS) structure.
